(19) United States
(12) Patent Application Publication
(10) Pub. No.: US 2010/0322231 A1
(43) Pub. Date: Dec. 23, 2010

(54) VOIP DEVICE AND METHOD FOR ADJUSTING INTERRUPT TIME THEREOF

(75) Inventor: CHENG-CHIH KUO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/535,770

(22) Filed: Aug. 5, 2009

(30) Foreign Application Priority Data
Jun. 18, 2009 (CN) 200910303418.9

(51) Int. Cl. H04L 12/66

(52) U.S. Cl. 370/352

(57) ABSTRACT

A voice over Internet protocol (VoIP) device for providing VoIP service for a telephone includes a time detecting module and a time adjusting module. The time detecting module is operable to receive a dual tone multiple frequency (DTMF) signal, detect interrupt time of the DTMF signal, and determine whether the interrupt time is less than a predefined time interval. The time adjusting module is operable to adjust the interrupt time to the predefined time interval upon the condition that the interrupt time is less than the predefined time interval.

### BACKGROUND

1. Technical Field

Embodiments of the present disclosure relate to network communication devices and more particularly to a voice over Internet protocol (VoIP) device and a method for adjusting interrupt time thereof.

2. Description of Related Art

Most voice over Internet protocol (VoIP) devices need to select subscriber line interface circuits (SLICs) according to interrupt time of a generic dual tone multiple frequency (DTMF) signal. FIG. 5 is a schematic diagram of one embodiment of the generic DTMF signal, where t1 is output time of the DTMF signal and t2 is the interrupt time of the DTMF signal.

The Japanese telecom operator, Nippon Telegraph and Telephone Public Corporation (NTT), stipulates that a minimum available interrupt time of the DTMF signal supported by the SLIC should be about 30 ms. However, practically, a minimum available interrupt time of the DTMF signal supported by most current SLICs for sale is about 37 ms (empirical value). Therefore, most SLICs are not available according to the specification, which limits the selection of the SLICs for the VoIP device.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an application environment and functional modules of one embodiment of a voice over Internet protocol (VoIP) device in accordance with the present disclosure;

FIG. 2 illustrates exemplary waveforms of DTMF signals having their interrupt time being adjusted by the VoIP device in accordance with the present disclosure;

FIG. 3 illustrates another exemplary waveforms of DTMF signals having their interrupt time being adjusted by the VoIP device in accordance with the present disclosure;

FIG. 4 is a flowchart of one embodiment of a method for adjusting interrupt time in accordance with the present disclosure; and

FIG. 5 illustrates exemplary waveforms of generic DTMF signals.

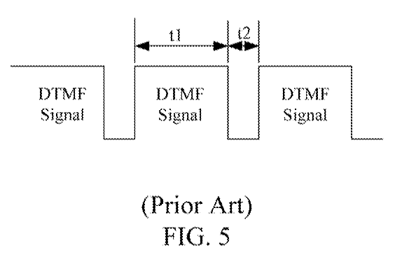

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

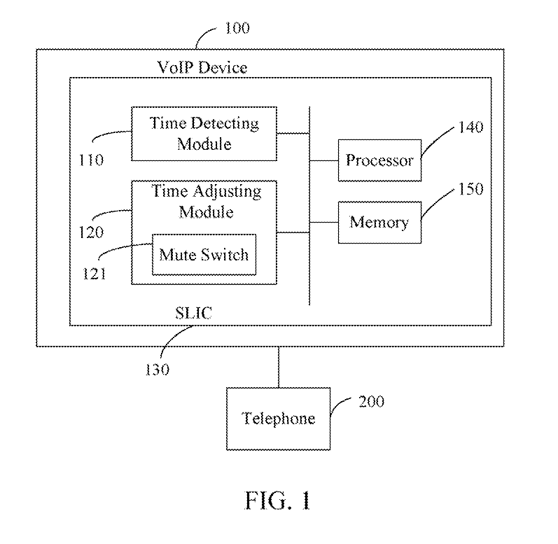

FIG. 1 is a schematic diagram of an application environment and functional modules of one embodiment of a voice over Internet protocol (VoIP) device 100 in accordance with the present disclosure. In one embodiment, the VoIP device 100 may be a VoIP gateway and is operable to provide VoIP service for a telephone 200. The VoIP device 100 can adjust interrupt time of dual tone multiple frequency (DTMF) signals, which makes selecting subscriber line interface circuits (SLICs) more flexible.

In one embodiment, the VoIP device 100 includes a time detecting module 110, a time adjusting module 120, a processor 140, and a memory 150. The time detecting module 110, the time adjusting module 120, the processor 140, and the memory 150 may be configured in a SLIC 130 of the VoIP device 100. The time detecting module 110 and the time adjusting module 120 are programs which are stored in the memory 150 and executed by the processor 140.

The time detecting module 110 is operable to receive a DTMF signal from the telephone 200, detect interrupt time of the DTMF signal, and determine if the interrupt time is less than a predefined time interval. In one embodiment, if the telephone 200 needs to give a ring over Internet via the VoIP device 100, the telephone 200 sends the DTMF signal to the VoIP device 100. Accordingly, the time detecting module 110 receives the DTMF signal from the telephone 200. In one embodiment, a minimum available interrupt time of the SLIC 130 is less than the predefined time interval. For example, if the minimum available interrupt time of the SLIC 130 is 37 ms, the predefined time interval may be 40 ms.

The time adjusting module 120 is operable to adjust the interrupt time to the predefined time interval upon the condition that the interrupt time is less than the predefined time interval. In one embodiment, the time adjusting module 120 includes a mute switch 121. The time adjusting module 120 adjusts the interrupt time to the predefined time interval by using the mute switch 121, as will be further discussed below.

It may be understood that the mute switch keeps the SLIC 130 silence during the predefined time interval so as to adjust the interrupt time to the predefined time interval. For example, if the predefined time interval is predefined as 3 seconds and the interrupt time is 5 seconds, then the mute switch keeps the SLIC 130 silence during 3 seconds, and then the interrupt time is adjusted to 3 seconds. If the mute switch 121 is on, the VoIP device 100 sends no signal.

The time adjusting module 120 is further operable to keep the interrupt time upon the condition that the interrupt time is not less than the predefined time interval. In one embodiment, the time adjusting module 120 makes no change of the interrupt time so as to keep the interrupt time.

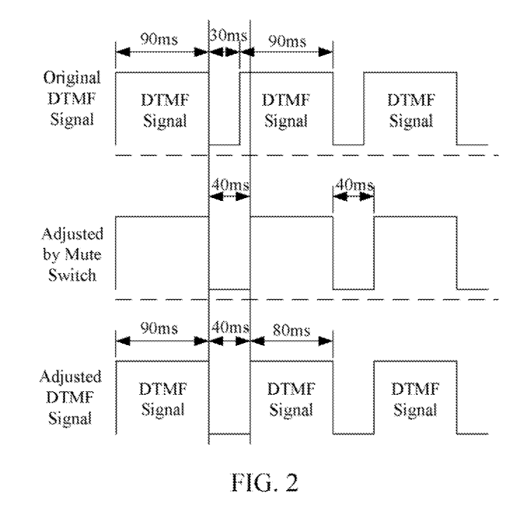

FIG. 2 illustrates exemplary waveforms of DTMF signals having their interrupt time being adjusted by the VoIP device 100 in accordance with the present disclosure. In one embodiment, the minimum available interrupt time of the SLIC 130 is 37 ms. However, the interrupt time of the DTMF signal received from the telephone 200 by the time detecting module 110 is 30 ms which is less than 37 ms. As such, the SLIC 130 cannot detect the DTMF signal whose interrupt time is 30 ms. Therefore, the mute switch 121 of the time adjusting module 120 keeps the SLIC 130 silence during the predefined time interval (40 ms) so as to adjust the interrupt time of the DTMF signal to 40 ms. The adjusted interrupt time 40 ms is more than 37 ms, which conforms to NTT guidelines. Accordingly, the SLIC 130 can detect the DTMF signal with the adjusted interrupt time.

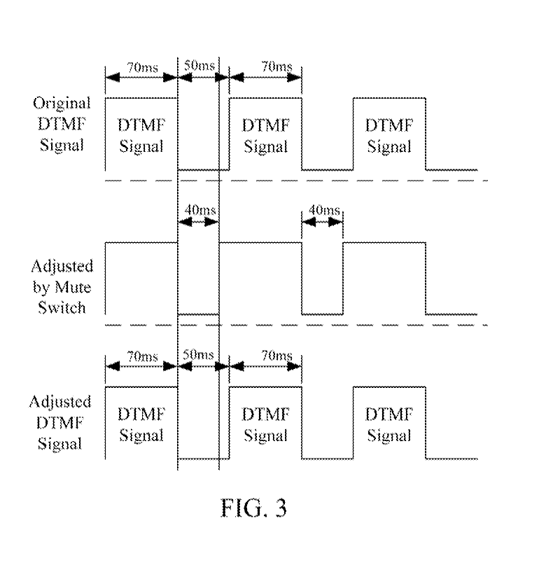

FIG. 3 illustrates another exemplary waveforms of DTMF signals having their interrupt time being adjusted by the VoIP device 100 in accordance with the present disclosure. In one embodiment, the minimum available interrupt time of the SLIC 130 is 37 ms and the interrupt time of the DTMF signal received from the telephone 200 by the time detecting module 110 is 50 ms which is more than 37 ms and suitable for the specification. Accordingly, the SLIC 130 can detect the DTMF signal whose interrupt time could be kept.

In embodiments of the present disclosure, the VoIP device 100 adjusts the interrupt time of the DTMF signal by way of the mute switch 121 of the time adjusting module 120, so selection of the SLIC 130 need not be limited by the specification of the interrupt time and makes the selection of the SLIC 130 more flexible. In addition, the VoIP device 100 can adjust the interrupt time of the DTMF signal by way of the mute switch 121 of the time adjusting module 120, which makes what would be an otherwise unavailable SLIC available for the specification. Accordingly, the SLIC need not to be changed, which reduces costs.

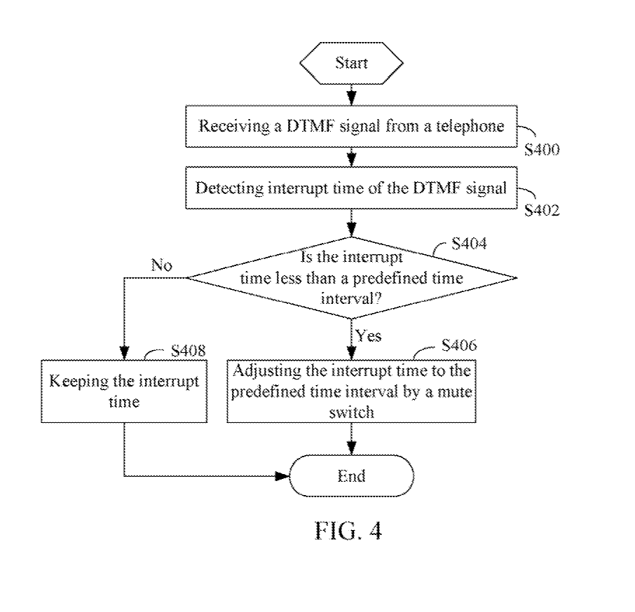

FIG. 4 is a flowchart of one embodiment of a method for adjusting interrupt time of the VoIP device 100 in accordance with the present disclosure. The method may be embodied in the VoIP device 100, and is executed by the functional modules such as those of FIG. 1. Depending on the embodiment, additional blocks may be added, others deleted, and the ordering of the blocks may be changed while remaining well within the scope of the disclosure.

In block S400, the time detecting module 110 receives a dual tone multiple frequency (DTMF) signal from the telephone 200.

In block S402, the time detecting module 110 detects interrupt time of the DTMF signal.

In block S404, the time detecting module 110 determines whether the interrupt time is less than a predefined time interval.

If the interrupt time is less than the predefined time interval, then in block S406, the time adjusting module 120 adjusts the interrupt time to the predefined time interval. In one embodiment, the time adjusting module 120 adjusts the interrupt time to the predefined time interval by using the mute switch 121 to keep the SLIC 130 silence during the predefined time interval.

If the interrupt time is not less than the predefined time interval, then in block S408, the time adjusting module 120 makes no change of the interrupt time so as to keep the interrupt time.

Therefore, the VoIP device 100 can adjust the interrupt time of the DTMF signal by way of the mute switch 121 of the time adjusting module 120, which makes an otherwise unavailable SLIC available for the specification and accordingly reduces costs by avoiding having to change the SLIC. In addition, the selection of the SLIC 130 need not be limited to a region's interrupt time specifications, which makes the selection of the SLIC 130 more flexible.

While various embodiments and methods of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A voice over Internet protocol (VoIP) device for providing VoIP service for a telephone, the VoIP device comprising a processor, a memory, and one or more programs, wherein the one or more programs are stored in the memory and operable to be executed by the processor, the programs comprise:
a time detecting module operable to receive a dual tone multiple frequency (DTMF) signal from the telephone, detect interrupt time of the DTMF signal, and determine if the interrupt time is less than a predefined time interval; and
a time adjusting module operable to adjust the interrupt time to the predefined time interval upon the condition that the interrupt time is less than the predefined time interval.

2. The VoIP device as claimed in claim 1, wherein the time adjusting module is further operable to keep the interrupt time upon the condition that the interrupt time is not less than the predefined time interval.

3. The VoIP device as claimed in claim 1, further comprising a subscriber line interface circuit (SLIC), wherein the time detecting module and the time adjusting module are configured in the subscriber line interface circuit.

4. The VoIP device as claimed in claim 3, wherein a minimum available interrupt time of the SLIC is less than the predefined time interval.

5. The VoIP device as claimed in claim 3, wherein the time adjusting module comprises a mute switch.

6. The VoIP device as claimed in claim 5, wherein the time adjusting module adjusts the interrupt time to the predefined time interval by using the mute switch to keep the SLIC silence during the predefined time interval.

7. A method for adjusting interrupt time of a voice over Internet protocol (VoIP) device providing VoIP service for a telephone, comprising:
receiving a dual tone multiple frequency (DTMF) signal from the telephone;
detecting interrupt time of the DTMF signal;
determining whether the interrupt time is less than a predefined time interval;
adjusting the interrupt time to the predefined time interval if the interrupt time is less than the predefined time interval;
processing the above blocks with at least one processor.

8. The method as claimed in claim 7, further comprising:
keeping the interrupt time if the interrupt time is not less than the predefined time interval.

9. The method as claimed in claim 7, wherein the VoIP device comprise a mute switch and a subscriber line interface circuit (SLIC).

10. The method as claimed in claim 9, wherein the block of adjusting the interrupt time to the predefined time interval comprises:
using the mute switch to keep the SLIC silence during the predefined time interval.
